(19) United States
(12) Patent Application Publication
(10) Pub. No.: US 2003/0227862 A1
(43) Pub. Date: Dec. 11, 2003

(54) Rewritable compact disk having determining function for record data

(75) Inventor: Stephen Yang, Hsinchu (TW)

Correspondence Address: BACON & THOMAS, PLLC, 625 SLATERS LANE, FOURTH FLOOR, ALEXANDRIA, VA, 22314

(73) Assignee: GIGASTORAGE CORPORATION, Hsinchu (TW)

(21) Appl. No.: 10/161,716

(22) Filed: Jun. 5, 2002

(51) Int. Cl. G11B 3/70; G11B 5/84; G11B 7/26

(52) U.S. Cl. 369/273

(57) ABSTRACT

The present invention provides a rewritable compact disk (CD-RW) having determining function for record data comprising a transparent substrate, a recording layer, a reflection layer, a protection layer, and a labeling layer, the improvement includes an uncovered scale portion located in said labeling layer for determining record data of said CD-RW from a side of said labeling layer.

### FIELD OF THE INVENTION

The invention herein relates to a rewritable compact disk, particularly, relates to a rewritable compact disk having determining function for record data.

### BACKGROUND OF THE INVENTION

Please referring to the FIG. 1, a traditional rewritable compact disk (CD-RW) 1 comprises a substrate 2, a recording layer 3, a reflection layer 4, a protection layer 5, and a labeling layer 6. The recoding layer 3 is adopted for recording data, and the reflection layer 4 is adopted for reflecting the laser beam. Furthermore, the protection layer 5 is adopted for protecting the reflection layer 4 from scraping, and the labeling layer 6 may be adopted for labeling information of brand name and/or specification of the CD-RW 1. In general, when a CD-RW player is reading data from a disk, the disk is rotated in a uniform speed; therefore, the data volume of the inner part of each circle of the disk is smaller than the outer part.

The labeling layer 6 of the traditional CD-RW 1 adopts screen printing technique to print pattern on the protection layer 6. The printings include brand name, specification of the CD-RW, and/or record data type, such as video data, or audio data. Due to the CD-RW player is getting more and more common, the demand of CD-RW 1 is getting increasing; for example, some demand is because of recording audio information, and some is because of a general data. However, because different circle of CD-RW has different data volume, when a CD-RW records only a little, it is unable to determine the record data volume unless there is a computer to read it.

### SUMMERY OF THE INVENTION

In view of the aforementioned problem, the main object of the present invention is to provide a rewritable compact disk having determining function for record data by human eyes.

The present invention provides a rewritable compact disk (CD-RW) having determining function for record data comprising a transparent substrate, a recording layer, a reflection layer, a protection layer, and a labeling layer, the improvement includes an uncovered scale portion located in said labeling layer for determining record data of said CD-RW from a side of said labeling layer.

### BRIEF DESCRIPTION OF THE DRAWINGS

The present invention will be better understood from the following detailed description of preferred embodiments of the invention, taken in conjunction with the accompanying drawings, in which

FIG. 1. illustrates a cross-section of a CD-RW in prior art;

FIG. 2 illustrates a top view of a CD-RW in accordance with the present invention;

FIG. 3 illustrates a cross-section in accordance with the 3-3 line in the FIG. 2; and

FIG. 4. is an embodiment example of a top view of a CD-RW with recorded data therein.

### DESCRIPTION OF THE PREFERRED EMBODIMENTS

The following descriptions of the preferred embodiments are provided to understand the features of the present invention.

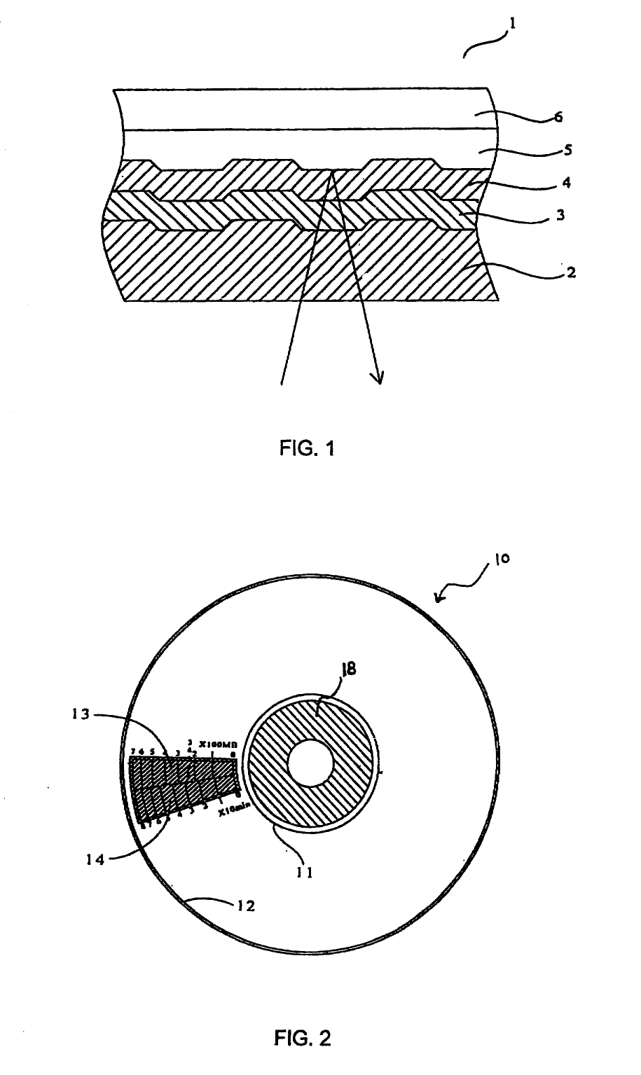

The present invention provides a rewritable compact disk (CD-RW) 10 having determining function for record data as shown in FIG. 2. The CD-RW 10 of this invention as shown in FIG. 3 comprises a transparent substrate 2, a recording layer 3, a reflection layer 4, a protection layer 5, and a labeling layer 6, the improvement shown in FIG. 2 includes an uncovered scale portion located in said labeling layer 6 for determining record data of said CD-RW 10 from one side thereof. Besides, said uncovered scale portion further comprises a volume scale 13 and a time scale 14. And furthermore, the labeling layer 6 may be printed with brand name or specification information etc.

Referring to the FIG. 2, the volume scale 13 and the time scale 14 of the CD-RW 10 provided in accordance with the present invention is formed by uncovering scale portion in the labeling layer 6 for record data, which may be located between the inner circle 11 and outer circle 12. Therefore, it does not has any dye on the stripe area 18, and may be printing between the inner circle 11 and outer circle 12. The data volume of the inner part of each circle of the CD-RW is smaller than the outer part; therefore, the volume scale 13 and the time scale 14 are not distributed in linear, which are shown in FIG. 2 that the scale 13, 14 located closer to the inner part have greater graduation. For example, in the FIG. 2, the CD-RW 10 has volume of 700 MB and 80 min. for audio recording. Thus, graduation of the volume scale 13 is from 0 to 7, and its unit is 100 MB; and graduation of the time scale 14 is from 0 to 8, and its unit is 10 min.

As the description of above, the CD-RW 10 comprises a transparent substrate 2, a recording layer 3, a reflection layer 4, a protection layer 5, and a labeling layer 6, wherein the substrate 2 and the recording layer 3 are transparent for light. In addition, the reflection layer 4 is formed by sputtering aluminum, so it has a specific thickness for light transmitting through. The labeling layer 6 in accordance with this invention comprises an uncovered scale portion with volume scale 13 and time scale 14 for determining record data of said CD-RW 10. The uncovered scale portion actually has no dye thereon; therefore, please referring to the FIG. 3, printing area 61 and 62 are covered with dye, and an uncovered portion 63 is formed as well. Moreover, light transmitting the labeling layer 6 with dye thereon is much fainter than transmitting the uncovered portion 63. Therefore, it is easy to see the volume scale 13 and time scale 14 formed in the labeling layer 6 from one side of the CD-RW 10.

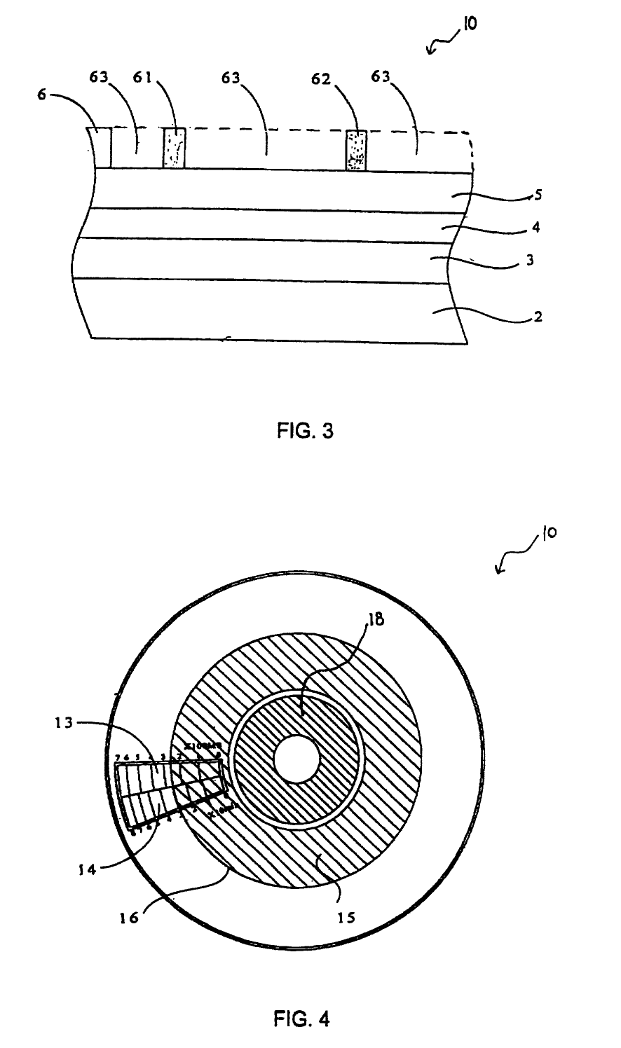

The present invention may be embodied in a preferred example, referring to the FIG. 4, to see the CD-RW 10 from the other side (the side of substrate 2), it is obvious to tell recorded area from unrecorded area. The recorded area 15 as shown in the FIG. 4 has a circumference 16 located in the middle between the inner circle 11 and the outer circle 12. If there is no scale showing on the labeling layer, it would be misunderstanding with 350 MB recorded data in CD-RW. In fact, it has only about 250 MB recorded data in the CD-RW 10, which may cause a big error therein without an accurate scale. Users can get accurate information about the CD-RW 10 in accordance with the volume scale 13 and time scale 14 of this invention; for example, it records 250 MB volume and remains 450 MB volume available for record data. Furthermore, the labeling layer 6 may be formed with different screen printing for different scale in accordance with the present invention, which is very easy to produce for the people who know the skills in this art.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

What is claimed is:

1 A rewritable compact disk (CD-RW) having determining function for record data comprising a transparent substrate, a recording layer, a reflection layer, a protection layer, and a labeling layer, the improvement includes:
an uncovered scale portion located in said labeling layer for determining record data of said CD-RW from a side of said labeling layer.

2 The CD-RW of claim 1, said uncovered scale portion further comprises a volume scale.

3 The CD-RW of claim 1, said uncovered scale portion further comprises a time scale.
